(19) United States
(12) Patent Application Publication
(10) Pub. No.: US 2009/0091576 A1
(43) Pub. Date: Apr. 9, 2009

(54) INTERFACE PLATFORM

(76) Inventor: Jayanta Kumar Maitra, San Diego, CA (US)

Correspondence Address: NYDEGGER & ASSOCIATES, 348 OLIVE STREET, SAN DIEGO, CA, 92103, US

(21) Appl. No.: 11/869,164

(22) Filed: Oct. 9, 2007

(51) Int. Cl. G06F 15/16

(52) U.S. Cl. 345/502; 345/501

(57) ABSTRACT

A system and method for presenting video/graphics images on a monitor requires a control unit, with a central processing unit (CPU), a system memory and a frame buffer that are mounted on a motherboard. It also includes a display module, without memory, that is remotely distanced from the control unit and from its motherboard. In this configuration, the display module includes a graphics processing unit (GPU) that is connected to a video monitor. In operation of the system, memory and frame buffer functions are controlled by the CPU in the control unit. A high speed serial bus interlink, that may either be a wire, fiber, or wireless connection, connects the control unit with the display module where images are composed for presentation on the monitor.

### FIELD OF THE INVENTION

The present invention pertains generally to systems and methods for displaying video/graphics images. More particularly, the present invention pertains to systems and methods that use a Graphics Processing Unit (GPU) to compose video/graphics images in response to an application program that is managed by a Central Processing Unit (CPU). The present invention is particularly, but not exclusively, useful as a system or method wherein the GPU is not resident with the CPU on a motherboard but, instead, is remotely distanced from the CPU and from the motherboard.

### BACKGROUND OF THE INVENTION

With a typical computer system, the presentation of video/graphics images is done with the intent to sequentially display images of an object from variously different perspectives (e.g. a rotating cube). To do this, a central processing unit (CPU) in the computer executes an application program that performs the required visual manipulations (e.g. rotate the cube). For this purpose, the application program is kept in the form of code in the computer's system memory. In accordance with this application program, pixels (i.e. content) from a frame buffer are organized by the CPU, and are composed by a graphics processing unit (GPU) for presentation on a video monitor. Typically, all of these components (i.e. CPU, GPU, frame buffer and system memory) reside in the computer on a same motherboard. More specifically, the GPU and frame buffer are typically located side-by-side and use a common private bus.

Not surprisingly, a more powerful GPU is capable of composing and manipulating video/graphics images faster and with greater detail than can a less powerful GPU. In addition to its increased power requirements, however, a more powerful GPU will be larger and will generate more heat during its operation than will a less powerful counterpart. These operational factors effectively preclude the use of more powerful GPUs on the smaller computers, such as notebook or laptop computers. Nevertheless, such smaller computers are widely used, and many of them have a memory with their respective frame buffers that is capable of storing the required pixels for quite complicated video/graphics images.

With the above in mind, it is an object of the present invention to provide a system and method for presenting video/graphics images on a monitor wherein a small computer (e.g. notebook or laptop computer) can use any GPU, regardless of the size or power requirements of the GPU. Another object of the present invention is to provide a system and method for presenting video/graphics images on a monitor wherein the system's GPU can be physically and structurally separated from the system's frame buffer. Yet another object of the present invention is to provide a system and method for presenting video/graphics images on a monitor wherein a remotely positioned GPU, and an associated video monitor, can accommodate a plurality of separate computers and their respective memories. Still another object of the present invention is to provide a system and method for presenting video/graphics images on a monitor that is relatively simple to manufacture, is easy to use and is comparatively cost effective.

### SUMMARY OF THE INVENTION

In accordance with the present invention a system and method for presenting video/graphics images involves a computer architecture that requires two separately identifiable components. One is a control unit that determines how the image is to be presented, and the other is a display module that composes and presents the image. Importantly, the system includes an interlink connection between the control unit and the display module that allows the display module to be remotely located, at an extended distance from the control unit.

The control unit of the present invention includes a central processing unit (CPU), a frame buffer, and a system memory. These components are co-located together, and interconnected to each other on a same motherboard. Further, the system memory contains code that can be used for the execution of an application program. On the other hand, the frame buffer contains pixels for use in the application program. And, the CPU organizes pixels in the frame buffer for execution of the application program. As indicated above, all of these components (i.e. CPU, frame buffer, and system memory) are on the same motherboard. Further, as envisioned for the present invention, these components will most likely reside on a notebook or laptop computer.

Separated from the control unit, and from its motherboard, the display module includes a graphics processing unit (GPU) for composing the video/graphics images. It also includes a video monitor on which the video/graphics images are presented. As envisioned for the present invention, the combined GPU and monitor will be remotely distanced from the control unit. Functionally, although the display module itself (i.e. GPU and monitor) has no memory capability, it is nevertheless operable with a plurality of different control units. Each of these control units will, of course, have their own memory capability. Thus, a single control unit may be operable with a plurality of different display modules. Further, depending on functional requirements, various control units and various display modules may be positioned at a respective number of different locations.

An important aspect of the present invention is an interlink that connects a particular control unit with a particular display module. For purposes of the present invention, this interlink is preferably a high speed, serial bus, such as a Peripheral Component Interface Express (PCIE). It is to be appreciated, however, that the interlink may be a wire connection, a wireless connection, an internet connection or a fiber connection. In any case, the important functional aspect of the present invention is that, when an interlink is used, the GPU need not be resident on the motherboard with components of the control unit. Stated differently, the display module appears to be transparent to the individual control units.

In operation, the CPU can manipulate video/graphics images on the monitor in at least two different ways. For one, the CPU can communicate with the GPU via the frame buffer. For another, the CPU can communicate with the frame buffer, via the GPU. In either case, the GPU manipulates pixels obtained from the frame buffer, while the CPU controls execution of the application program. With this operation, the GPU is effectively able to process images (i.e. rendering, shading, orientation etc.).

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a system in accordance with the present invention;

FIG. 2 is a functional schematic of the present invention;

FIG. 3A is a representation of a wire or fiber connection for the interlink of the present invention;

FIG. 3B is a representation of a wireless connection for the interlink; and

FIG. 3C is a representation of an internet connection for the interlink.

### DESCRIPTION OF THE PREFERRED EMBODIMENTS

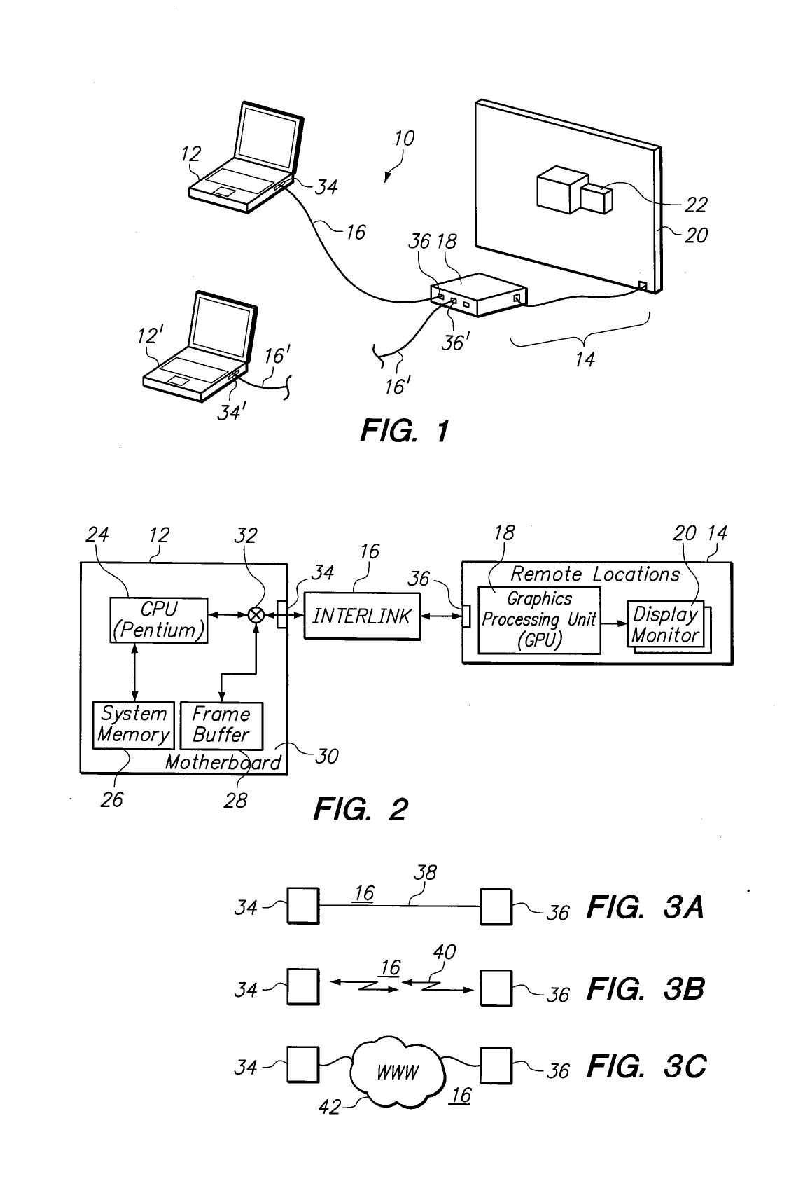

Referring initially to FIG. 1 a system for presenting a video/graphics image in accordance with the present invention is shown and is generally designated 10. As shown, the system 10 essentially includes a control unit 12 and a display module 14. As envisioned for the present invention, the control unit 12 will most likely be a personal computer (i.e. notebook or laptop type computer) of a type well known in the pertinent art. In any event, an interlink 16 is provided to connect the control unit 12 with the display module 14. As shown, several different control units 12 (e.g. control units 12 and 12′) can use the same display module 14 through respective interlinks 16 (e.g. interlinks 16 and 16′).

In detail, FIG. 1 shows that the display module 14 has an interface platform that includes a graphics processing unit (GPU) 18. This GPU 18 is then connected directly to a display monitor 20 on which an image 22 can be presented. The functional cooperation between the control unit 12 and the display module 14 will be best appreciated with reference to FIG. 2, wherein the functionality of components of the control unit 12, and of the display module 14, is shown in greater detail.

FIG. 2 shows that the control unit 12 (i.e. personal computer) includes a central processing unit (CPU) 24, a system memory 26 and a frame buffer 28. These components are shown interconnected to each other, and they are all resident on the same motherboard 30. Also, the control unit 12 is shown to include a dual port 32. For the system 10, this control unit 12 connects with the display module 14 via the interlink 16. In turn, the interlink 16 is connected to the control unit 12 via an access port 34, and it is connected to the display module 14 via an access port 36.

For purposes of the present invention, the interlink 16 can be of several different types, all well known in the pertinent art. For one embodiment, as shown in FIG. 3A, the interlink 16 can be a wire or fiber connection 38. For another, shown in FIG. 3B, the interlink 16 can be a wireless connection 40. For yet another embodiment, as shown in FIG. 3C, the interlink 16 can be an internet connection 42. In a preferred embodiment of the interlink 16, as shown in FIG. 3A, the interlink 16 is a high speed, serial bus of a type known in the pertinent art as a Peripheral Component Interface Express (PCIE). For such an interlink 16 (i.e. PCIE) the access port 34 of control unit 12 may be a standard ExpressCard™ interface slot of a type available on many laptop computers.

In the operation of the system 10, CPU 24 of control unit 12 coordinates the activities of all the other components. Specifically, to begin an operation, the CPU 24 retrieves code from the system memory 26 for use in executing an application program. The CPU 24 then organizes pixels in the frame buffer 28 for use in the application program, and it executes the application program. For this execution of the application program, the GPU 18 receives organized pixels from the frame buffer 28, via the interlink 16, and presents them as a video/graphics image 22 on the display monitor 20. Manipulation of the image 22 on the monitor 20 can then be controlled as desired by the operator of control unit 12. More specifically, due to the functional capabilities of the dual port 32, the communication between CPU 24 and GPU 18 for manipulation of the image 22 can be done in either of two ways. For one, dual port 32 allows the CPU 24 to communicate directly with the frame buffer 28 for manipulation of the image 22. Alternatively, the CPU 24 can communicate with the GPU 18 via the frame buffer 28. In each case, communications between the CPU 24 and the GPU 18 are accomplished via the interlink 16.

It is important to note that although the GPU 18 can be considered as being functionally on the motherboard 30 (i.e. transparent), structurally it is in a remote location at a distance from the control unit 12 and its motherboard 30. As a practical matter, the distance of separation between the control unit 12 and the GPU 18 may be significant (e.g. thousands of miles).

In overview, there are two modes of communication between the CPU 24 of the control unit 12 and the GPU 18 in the display unit 14. In a first mode, the CPU 24 of the control unit 12 writes the command in a designated space of the frame buffer 28 and then flags the GPU 18 in display unit 14 via the interlink 16 to service the command. The GPU 18 in turn reads the command out of the frame buffer 28 via interlink 16 and consequently reads the pixels from frame buffer 28. The GPU 18 then manipulates the pixels in accordance with the command before displaying the image 22 on the monitor 20.

In the second mode, the CPU 24 of the control unit 12 directly writes the command to the GPU 18 of the display unit 14. The GPU 18 in turn reads the pixels out of the frame buffer 28 via interlink 16 and then manipulates them in accordance with the command before displaying the image 22 on the monitor 20.

While the particular Interface Platform as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for presenting a video/graphics image on a monitor, the system comprising:
a control unit for organizing pixels in accordance with an application program;
a graphics processing unit remotely positioned at a distance from the control unit; and
an electrical interlink for transferring organized pixels from the control unit to the graphics processing unit for use by the graphics processing unit to compose the video/graphics image, wherein the graphics processing unit is connected to the monitor for presentation of the image on the monitor, and wherein the control unit controls manipulation of the image on the monitor.

2. A system as recited in claim 1 wherein the control unit comprises:
a central processing unit for executing the application program;
a frame buffer connected to the central processing unit, wherein the frame buffer contains the pixels for use in the application program; and
a system memory connected to the central processing unit and having code for execution of the application program by the central processing unit.

3. A system as recited in claim 2 wherein the central processing unit communicates directly with the frame buffer for manipulation of the image.

4. A system as recited in claim 2 wherein the central processing unit communicates with the graphics processing unit the via frame buffer for manipulation of the image.

5. A system as recited in claim 1 wherein the interlink is a high speed bus.

6. A system as recited in claim 5 wherein the interlink is selected from a group consisting of a wire connection, a wireless connection, and a fiber connection.

7. A system as recited in claim 5 wherein the interlink is a serial bus, Peripheral Component Interface Express (PCIE).

8. A system as recited in claim 1 further comprising a plurality of control units and a respective plurality of interlinks for use with the graphics processing unit.

9. A system as recited in claim 1 further comprising a plurality of graphics processing units and a respective plurality of interlinks for use with the central processing unit.

10. An assembly for electrically connecting a control unit with a display module which comprises:
a first connector mounted on the control unit;
a second connector mounted on the display module and remotely positioned at a distance from the first connector; and
an interlink, wherein the interlink is interactive with the first connector for receiving pixels from the control unit with the pixels being organized in accordance with an application program, and wherein the interlink is interactive with the second connector for transferring the organized pixels to the display module for presentation as a video/graphics image.

11. An assembly as recited in claim 10 wherein the display module comprises:
a graphics processing unit for composing the organized pixels into the video/graphics image; and
a monitor for presenting the video/graphics image.

12. An assembly as recited in claim 11 wherein the control unit is mounted on a motherboard and comprises:
a central processing unit for executing the application program;
a frame buffer connected to the central processing unit, wherein the frame buffer contains the pixels for use in the application program; and
a system memory connected to the central processing unit and having code for execution of the application program by the central processing unit.

13. An assembly as recited in claim 12 wherein the central processing unit communicates with the graphics processing unit via the frame buffer for manipulation of the image.

14. An assembly as recited in claim 12 wherein the central processing unit communicates with the frame buffer via the graphic processing unit for manipulation of the image.

15. An assembly as recited in claim 11 wherein the interlink is a high speed, serial bus and is selected from a group consisting of a wire connection, a wireless connection, and a fiber connection.

16. An assembly as recited in claim 15 wherein the interlink is a Peripheral Component Interface Express (PCIE).

17. A method for presenting a video/graphics image which comprises the steps of:
connecting a graphics processing unit (GPU) with a monitor at a first location to create a display module;
using a control unit at a second location to organize pixels in accordance with an application program, wherein the second location is remote and is at a distance from the first location; and
incorporating an interlink between the display module and the control unit, wherein the interlink is interactive with the control unit for receiving organized pixels therefrom, and is interactive with the display module for presentation of the organized pixels as the video/graphics image.

18. A method as recited in claim 17 wherein the control unit is mounted on a motherboard and comprises:
a central processing unit for executing the application program;
a frame buffer connected to the central processing unit, wherein the frame buffer contains the pixels for use in the application program; and
a system memory connected to the central processing unit and having code for execution of the application program by the central processing unit.

19. A method as recited in claim 18 wherein the central processing unit communicates directly with the frame buffer for manipulation of the image.

20. A method as recited in claim 18 wherein the central processing unit communicates with the graphics processing unit via the frame buffer for manipulation of the image.
